(19) United States
(12) Patent Application Publication
(10) Pub. No.: US 2010/0034222 A1
(43) Pub. Date: Feb. 11, 2010

(54) LASER SOURCE FOR LIDAR APPLICATION

(75) Inventors: Simon Richard, Orsay (FR); Arnaud Brignon, Bourg-La-Reine (FR)

Correspondence Address: LOWE HAUPTMAN HAM & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/301,063

(22) PCT Filed: May 25, 2007
(86) PCT No.: PCT/EP2007/055104

§ 371 Date: May 13, 2009

(30) Foreign Application Priority Data
May 30, 2006 (FR) 06/04811

(51) Int. Cl. H01S 3/098

(52) U.S. Cl. 372/18

(57) ABSTRACT

The invention relates to a source comprising a self-adaptive main laser cavity comprising at least one main amplifying medium in a main direction and several mirrors making it possible to create a gain hologram within said main amplifying medium by interference of a first optical wave in the main direction and a second optical wave in a direction different from the main direction, said wave being generated by the main amplifying medium, characterized in that it also comprises a secondary laser source delivering photons at a frequency that they impose on the main cavity and means of introducing said photons within the main laser cavity, said secondary source making it possible to force the main source to function on the frequency imposed by this so-called secondary source.

### CROSS-REFERENCE TO RELATED APPLICATIONS

The present Application is based on International Application No. PCT/EP2007/0055104, filed on May 25, 2007, which in turn corresponds to French Application No. 0604811, filed on May 30, 2006, and priority is hereby claimed under 35 USC §119 based on these applications. Each of these applications are hereby incorporated by reference in their entirety into the present application.

### FIELD OF THE INVENTION

The field of the invention is that of high-energy laser sources for LIDAR systems, notably for optronics, industrial and scientific applications. For example, these systems are widely used in the atmospheric sciences (detection of pollutants and aerosols, dynamic measurements of air mass and cloud movements), the planet sciences (mapping the reliefs of the planets, Lidars onboard satellites for meteorological measurements). These systems can also be used in aeronautics (airborne Lidars or Lidars in airports) for detecting turbulences and making it possible to increase air traffic while ensuring its improved safety.

### BACKGROUND OF THE INVENTION

As a general rule, the spatial and spectral quality of the laser used in a Lidar system, and its energy and its power, are crucial and directly determine the overall system performance levels. However, it becomes difficult to maintain a good beam quality when the energy or the power of the laser increases. In practice, the thermal effects within the laser crystal used as amplifying medium create strong phase aberrations which contribute to distorting the wave front and reducing the beam quality. The conventional laser sources are therefore often limited in energy/power because of these problems.

Moreover, the laser sources for LIDAR systems use a certain number of critical, complex and costly components for creating pulses and for spectrally refining the laser emission:
To obtain pulses of a few tens of nanosecond, the conventional sources use an active triggering system such as a Pockels cell or an acousto-optical cell.
To spectrally refine the laser emission, it is essential to servo-control the laser cavity to another low-power, continuous, single-frequency laser. To produce this servo-control, one of the mirrors of the laser cavity must be mounted on a piezo-electric shim to adjust the length of the cavity by means of an electronic feedback loop. The length of the laser cavity must thus be controlled in real time by means of an electronic feedback loop.

FIG. 1 illustrates this type of laser source:

The cavity comprises between 2 mirrors R1 and R2, an amplifying medium MA1 that can typically be a laser rod made of Nd³⁺:Y₃Al₅O₁₂ (Nd:YAG) pumped by lamps or diodes, the length L of the cavity is thus defined between the mirrors R1 and R2. To benefit from a high-energy pulsed source, the cavity also comprises a trigger which is not represented which acts as a switch making it possible after a certain energy buildup time within said cavity, to release the laser beam.

To force the laser cavity to oscillate on a single longitudinal mode corresponding to a single frequency, this laser cavity is servo-controlled by a small laser cavity, called secondary SL relative to the main cavity defined previously. The small secondary laser having a cavity length l, is a single-frequency laser which makes it possible to inject into the primary laser cavity photons hν at a single frequency ν. The laser beam in the main cavity preferably oscillates on this frequency provided that this frequency corresponds to a resonance frequency of the primary cavity. For this condition to be satisfied, it is essential for the respective lengths of the cavities to satisfy the equation:

L/l=λ, N being an integer number and [symbol] being the laser wavelength.

This condition is satisfied by introducing into the cavity of the primary laser a piezo-electric shim Cl making it possible to adjust the length L of the cavity of the primary laser, and this for any operating frequency.

In order to control the laser spatially (correcting laser crystal aberrations), temporally (pulse generation) and spectrally (single-frequency operation), there has also been proposed another type of source architecture which uses the four-wave mix in the laser medium as illustrated in FIG. 2 and which is notably described in the following articles: Bel'dyugin et al., Solid-state lasers with self-pumped phase-conjugate mirrors in an active medium, Sov. J. Quantum Electron., vol. 19, pages 740-742 (1989); Damzen, Green and Syed, Self-adaptive solid-state laser oscillator formed by dynamic gain-grating holograms, Optics Letters, vol. 20, pages 1704-1706 (1995); Sillard, Brignon and Huignard, Gain-grating analysis of a self-starting self-pumped phase-conjugate Nd:YAG loop resonator, IEEE J. Quant. Electron, vol. 34, pages 465-472 (1998). Such an architecture makes it possible to obtain a single-frequency emission without recourse to a secondary laser.

This ring laser is formed by an output mirror having a low reflectivity R1 (typically 4%-10%) and an amplifying medium MA1 (laser head 1) in which the waves inscribe a dynamic gain hologram.

For this, the mirrors are arranged so that it is possible to make the waves interfere according to differentiated directions. The amplifying medium generates waves in all the directions, only some can be amplified in the laser cavity. In FIG. 2, the interference phenomenon is diagrammatically represented by the interference of the waves A1, A3. The waves A1 and A3 inscribe a transmission gain array, also called amplitude hologram. The wave A2 rereads the array and generates a diffracted wave A4.

The waves A2 and A3 also inscribe a reflection array which is reread by the wave A1.

The wave A1 is thus called pump wave because it inscribes a transmission array.

The wave A2 is also designated as a pump wave because it inscribes a reflection array.

The wave A3 is a signal wave.

The wave A4 is a conjugate wave for rereading the arrays inscribed in the amplifying medium.

The hologram corresponding to the inscribed amplitude arrays constitutes, in certain conditions, a phase conjugation mirror, which means that the wave A4 is the phase-conjugate wave of the signal wave A3. If the wave A3 has undergone phase distortions in its propagation in the cavity, the phase-conjugate wave A4 will be corrected of its aberrations in its reverse propagation in the cavity. Such a phase conjugation mirror will therefore make it possible to compensate the phase aberrations of the laser media and therefore create an output beam of good spatial quality.

For the gain hologram to be effective, it is essential for the contrast of the interference fringes to be high. It is therefore important for the waves A1 and A3 to have amplitudes of the same order of magnitude. To favor this phenomenon, there is introduced into the cavity a non-reciprocal element ENR, making it possible to introduce losses in the clockwise direction indicated in FIG. 2 and not in the reverse direction. The non-reciprocal element can typically comprise a Faraday rotator, two polarizers and a half-wave plate.

At the start, the process is initiated by the spontaneous emission from the amplifying medium MA1. The waves A1, A2, A3 and A4 deriving from this noise begin to inscribe the gain hologram. This hologram has a diffraction efficiency η. It is also possible to introduce other laser media having a gain G (MA2 illustrated in FIG. 2) to increase the effectiveness of the system. The losses of the cavity for a wave oscillating in the counterclockwise direction in FIG. 2 are designated by the letter T. When η×G×T>1, the oscillation condition is verified and the 4 waves inside the cavity become increasingly intense on each turn in the cavity. The intensity at the laser output increases proportionally. In a few tens of nanoseconds, the amplification of the beam extracts all the energy stored in the amplifying media and the oscillation stops. The laser therefore supplies a light pulse.

The laser emission is naturally single-frequency, the gain hologram producing a very fine spectral filter.

Nevertheless, although this type of self-adaptive laser cavity is single-frequency, from one pulse to another this frequency can vary.

### SUMMARY OF THE INVENTION

To resolve this problem, the present invention proposes a novel laser source of the same type with self-adaptive cavity with four-wave mix and presenting a secondary source making it possible to force the main source to function on the frequency imposed by this small ancillary source.

More specifically, the subject of the invention is a laser source comprising a self-adaptive main laser cavity comprising at least one main amplifying medium in a main direction and several mirrors making it possible to create a gain hologram within said main amplifying medium by interference of a first optical wave in the main direction and a second optical wave of different direction, said waves being generated by the main amplifying medium.

The source also comprises a secondary laser source delivering photons at a frequency that they impose on the main cavity and means of introducing said photons within the main laser cavity, said secondary source making it possible to force the main source to function on the frequency imposed by this so-called secondary source.

Advantageously, the secondary laser source is placed according to the direction of the second optical wave.

Advantageously, the laser source comprises a non-reciprocal element making it possible to create losses in a non-reciprocal manner on waves flowing in one direction or in the other within the main laser cavity.

This element can comprise a Faraday rotator, two polarizers and a half-wave phase plate.

According to a variant of the invention, the mirrors are strongly reflective, the laser beam being extracted from the main laser cavity by the loss pathway that the non-reciprocal element generates.

According to a variant of the invention, the laser source also comprises optical means for creating a scaling on the first and second waves so as to compensate the divergence that affects the waves after propagation within the main laser cavity.

The optical means can be of pair of convergent lens and divergent lens type.

They can be placed close to the main amplifying medium.

According to a variant of the invention, the main cavity comprises at least one second amplifying medium to increase the amplification gain within the main laser cavity.

According to a variant of the invention, this second amplifying medium can advantageously be replaced by two amplifying media between which is placed a 90° polarization rotator to compensate the effects of depolarization introduced by thermal effect in these two amplifying media.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 illustrates an exemplary laser source for Lidar according to the prior art;

FIG. 2 illustrates an exemplary laser source for Lidar comprising a four-wave self-adaptive cavity according to the prior art;

FIG. 3 illustrates a first exemplary laser source for Lidar according to the invention;

FIG. 4 illustrates a second exemplary laser source for Lidar according to the invention;

FIG. 5 illustrates a third exemplary laser source according to the invention comprising a split amplifying medium and a 90° polarization rotator.

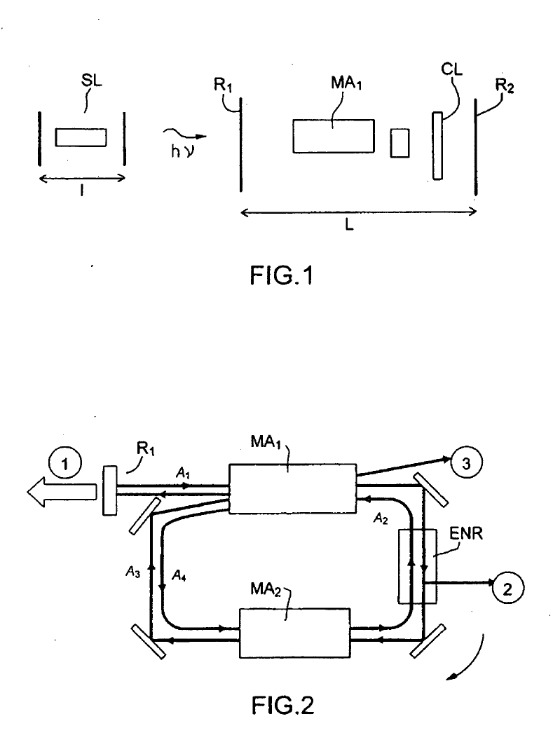

### DETAILED DESCRIPTION OF THE DRAWINGS

As a general rule, the laser source according to the invention comprises an amplifying medium within which is created a transmission gain array as described in a self-adaptive cavity according to the prior art.

To resolve the problem of the frequency of the laser that can change from one pulse to another and can be of the order of 1 gigahertz according to the prior art, the invention proposes to use a small low power laser making it possible to inject photons into the main laser cavity, these photons are amplified and impose their frequency on the main laser cavity. In the conventional injection systems, for the injected photons to be able to be amplified, their frequency must be resonant with the natural frequencies of the cavity as explained in the preamble to the invention. One of the mirrors of the cavity to be injected must be placed on a piezo-electric shim to adjust the length of the cavity by means of an electronic feedback loop.

According to the invention, there is no longer a need to control the length of the cavity to be injected since the cavity is self-adaptive and enclosed by a non-linear mirror formed by the four-wave mix of the beam present in the cavity. The dynamic gain hologram that is formed in the main amplifying medium is therefore automatically adapted to the frequency of the continuous laser.

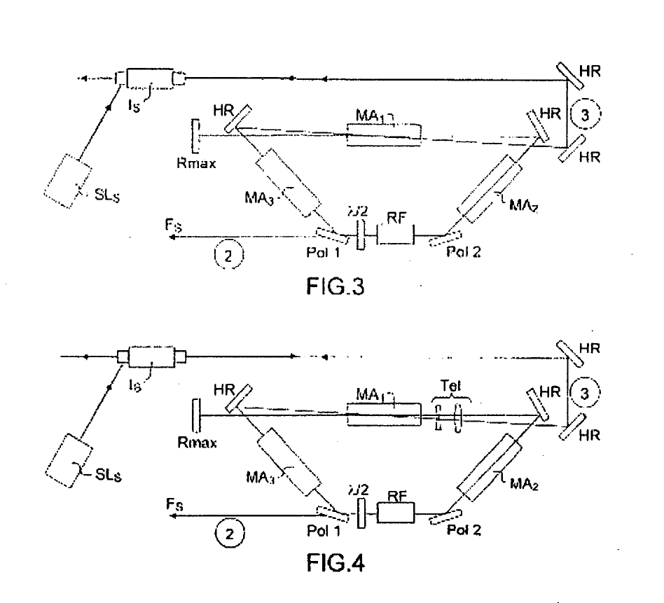

FIG. 3 illustrates a first example of laser according to the invention that advantageously uses 3 amplifying media. In practice, preference will generally be given to using several gain media to obtain a maximum gain (equal to the sum of the gains of each amplifying medium) within the laser cavity: a first amplifying medium MA1 within which is generated the gain hologram by interferences of the waves A1 and A3 and of the waves A2 and A3, a second amplifying medium MA2 and a third amplifying medium MA3.

The small low-power, single-frequency so-called secondary laser source SLs is injected into the main laser cavity via a non-reciprocal element of Faraday isolator type is to avoid the beam returns from the main cavity towards said secondary source.

A set of high reflectivity mirrors HR makes it possible to form the main laser cavity as according to the configuration of the known art comprising a self-adaptive cavity. However, advantageously, the mirror R1 corresponding to the output mirror of the prior art is replaced by a strongly reflective mirror Rmax to reduce the losses in the cavity and the output laser beam Fs is recovered at the level of the non-reciprocal element RF which can typically comprise a Faraday rotator and a half-wave phase plate, inserted between two polarizers Pol1 and Pol2. Typically, it has been experimentally validated that the uses of the mirror Rmax and of the output at the level of the non-reciprocal element would provide an increase in the output energy by a factor between 2 and 3.

According to a variant of the invention, it is also proposed to use optical means to compensate the divergence that is created on the intra-cavity amplified laser beam. These optical means can advantageously be of telescope type.

FIG. 4 illustrates such a configuration in which a set of convergent and divergent lenses is introduced close to the amplifying medium MA1 in which the interferences are produced. This telescope makes it possible to adapt the dimension of the beam to that of the laser rods. By calculating notably the trend of the dimension of the beam in the cavity, it appears that, without telescope, the beam could naturally achieve very large dimensions (diameter of 10 mm maximum at the level of the waves A1 and A2). Now, the laser rods generally have a smaller dimension (typically 4-7 mm diameter). The result of this is a very significant vignetting effect which very strongly degrades the beam quality and the stability of the laser. The telescope makes it possible to reduce the size of the beam in order for it to always remain adapted to the size of the laser rods. This telescope Tel can have a typical enlargement value of 1.5 (for example, a divergent lens of focal length −100 mm associated with a convergent lens of focal length +150 mm).

The telescope therefore makes it possible to improve the beam quality and the stability of the overall laser performance characteristics.

As a general rule, lasers delivering high-power pulses are subject to overheating problems generating depolarization problems. Now, most laser applications need a polarized output beam notably to be able to carry out frequency conversion operations in non-linear crystals. Moreover, the depolarization directly affects the beam quality and can reduce the laser's output energy. When the laser media are used at a high rate (typically >100 Hz), the depolarization effects become extremely problematic.

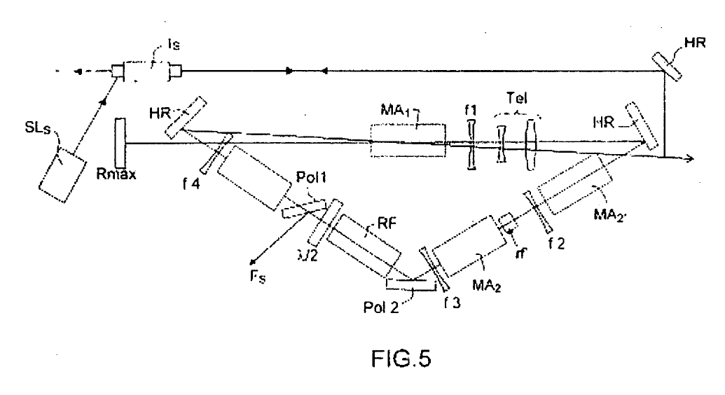

In order to partially compensate this effect, a variant of the invention proposes to split the amplifying medium that is located just before the output of the laser as shown by FIG. 5. The use of 2 identical amplifying media MA2, MA2′ and a 90° polarization rotator between the two makes it possible to compensate the depolarization of these two amplifying media. This figure also illustrates positions of lenses f1, f2, f3, f4 that make it possible to adapt the beam within the cavity.

### EXEMPLARY EMBODIMENT

The laser source according to the invention comprises:
a small continuous secondary laser source, delivering a few hundredths of μW
the self-adaptive cavity comprises 3 Nd:YAG amplifying media pumped by flash lamp or by laser diodes at 100 Hz, 2 amplifying media corresponding to the split media illustrated in FIG. 5.

Typically, it can concern laser rods of diameter equal to 6 mm and each presenting a gain gₒL of 3.5, the factor exp (gₒL) corresponding to the amplification factor of the laser beam within the cavity.
The output energy obtained can thus be greater than 300 mJ delivering pulses of 20 ns with a beam quality 1.5 times the diffraction limit.

With rod diameters of 10 mm, in a configuration identical to the preceding one, the output energy delivered becomes of the order of a joule.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A laser source comprising a self-adaptive main laser cavity having at least one main amplifying medium in a main direction and several mirrors for creating a gain hologram within said main amplifying medium by interference of a first optical wave in the main direction and a second optical wave in a direction different from the main direction, said waves being generated by the main amplifying medium, comprising:
a secondary laser source delivering photons at a frequency that they impose on the main cavity and means of introducing said photons within the main laser cavity, said secondary source for forcing the main source to function on the frequency imposed by the secondary source;
a non-reciprocal element for creating losses in a non-reciprocal manner on waves flowing in one direction or in the other within the main laser cavity.

2. The laser source comprising a self-adaptive main laser cavity as claimed in claim 1, wherein the mirrors are strongly reflective and the laser beam are being extracted from the main laser cavity from the non-reciprocal element that generates losses.

3. The laser source as claimed in claim 1, wherein the secondary laser source is placed according to the direction of the second optical wave.

4. The laser source as claimed in claim 1, wherein the non-reciprocal element comprises a Faraday rotator.

5. The laser source as claimed in claim 1, also comprising a polarization rotator to compensate for the depolarization effects introduced by the thermal effects in the amplifying media introduced into the cavity.

6. The laser source as claimed in claim 1, also comprising optical means (Tel) for creating a scaling on the first and second waves so as to adapt the diameter of the beams to the diameter of the amplifying medium or media of the cavity.

7. The laser source as claimed in claim 6, wherein the optical means are of pair of convergent lens and divergent lens type.

8. The laser source as claimed in claim 6, wherein the optical means are placed close to the main amplifying medium.

9. The laser source as claimed in claim 1, wherein the main cavity comprises at least one second amplifying medium to increase the amplification gain within the main laser cavity.

10. The laser source as claimed in claim 2, wherein the secondary laser source is placed according to the direction of the second optical wave.

11. The laser source as claimed in claim 2, wherein the non-reciprocal element comprises a Faraday rotator.

12. The laser source as claimed in claim 2, also comprising a polarization rotator to compensate for the depolarization effects introduced by the thermal effects in the amplifying media introduced into the cavity.

13. The laser source as claimed in claim 2, also comprising optical means (Tel) for creating a scaling on the first and second waves so as to adapt the diameter of the beams to the diameter of the amplifying medium or media of the cavity.

14. The laser source as claimed in claim 7, wherein the optical means are placed close to the main amplifying medium.

15. The laser source as claimed in claim 2, wherein the main cavity comprises at least one second amplifying medium to increase the amplification gain within the main laser cavity.

16. The laser source as claimed in claim 4, also comprising a polarization rotator to compensate for the depolarization effects introduced by the thermal effects in the amplifying media introduced into the cavity.

17. The laser source as claimed in claim 3, wherein the non-reciprocal element comprises a Faraday rotator.

18. The laser source as claimed in claim 4, also comprising a polarization rotator to compensate for the depolarization effects introduced by the thermal effects in the amplifying media introduced into the cavity.

19. The laser source as claimed in claim 5, also comprising optical means (Tel) for creating a scaling on the first and second waves so as to adapt the diameter of the beams to the diameter of the amplifying medium or media of the cavity.

20. The laser source as claimed in claim 8, wherein the main cavity comprises at least one second amplifying medium to increase the amplification gain within the main laser cavity.
